(19) United States
(12) Patent Application Publication
(10) Pub. No.: US 2013/0061302 A1
(43) Pub. Date: Mar. 7, 2013

(54) Method and Apparatus for the Protection of Computer System Account Credentials

(71) Applicants: Gregory Alan Colla, McMahons Point (AU); Neville Robert Jones, Anna Bay (AU)

(72) Inventors: Gregory Alan Colla, McMahons Point (AU); Neville Robert Jones, Anna Bay (AU)

(21) Appl. No.: 13/407,531

(22) Filed: Feb. 28, 2012

(30) Foreign Application Priority Data
Feb. 28, 2011 (AU) 2011900699

(51) Int. Cl. H04L 9/32

(52) U.S. Cl. 726/6; 726/7

(57) ABSTRACT

There is described methods, systems and software for creating, managing and using authentication credentials. The invention maintains for each user two authentication credentials—external and internal authentication credentials that share the same number of authentication factors of the same type. These are stored in a data store [1.4]. The user users the external authentication credential by a device [1.1] that is external to the network [1.8]. This is matched to the internal authentication credentials that are then used authenticate the user on the network [1.8]. It is an advantage of the invention that the internal authentication credentials are not stored on the device [1.1] leading to greater security. Also, the client software on the device [1.1] does not need to be customised in anyway to deliver this improved security.

### TECHNICAL FIELD

The present invention relates to the authentication of a user in networked computer data processing environments. In particular, but not limited to, systems where there exist one or more clients of varying capability connected via public data networks to one or more servers that form a network and provide application program services to the connected clients using client/server architectures.

### BACKGROUND ART

Organisations store information in a range of systems, such as file systems, databases, content management systems, record management systems, document management systems and email systems. The information may be made available to users and systems within the organisation's network using client-server systems, such as a web browser and web server, an email client and email server, a network file system client and file system server, or a database client-server system. The clients and servers communicate between each other using a range of public and proprietary application protocols.

The information stored and transported by these systems may range in sensitivity. Organisations have a responsibility to manage access to sensitive information.

The most common first step in providing a security layer around information in a client-server system is to require all clients to authenticate to the server before any access is granted. The nature of client authentication can vary and can include checks such as the client's machine address to requiring that a known end-user is using the client. Once the client is authenticated the amount of information it can access in the server system will be dictated by the authorisation rules defined in the server.

Historically, where a sizeable number of client-server systems were located inside an organisation's computer network it became sensible to allow users to present the same user authentication credentials to systems in the network, thereby reducing the number of credentials the user had to remember or have available. In implementation, a central system in the network securely stored and maintained the user authentication credentials and would use secure protocols such as Kerberos to authenticate the user to the application server. So, in modern computer networks the user logs into the network but then rarely logs in again to other systems such as e-mail and file servers—the central authority confirms the user identity to the application server without the user even being aware this has happened.

As an organisation's workforce becomes more mobile, the organisation may provide access to internal systems from outside the organisation, and by devices not under direct control of the organisation. The user's authentication credentials are entered by the user into the external device to access the network. These external access mechanism without additional controls increases the risk of data leakage from the organisation.

### SUMMARY OF THE INVENTION

In a first aspect there is provided a computer-implemented method of authenticating a user for access to a network, the method comprising:
receiving input authentication credentials from the user using a device that is external to the network, the input authentication credentials having one or more authentication factors, and each authentication factor having a type;
matching the input authentication credentials to stored external authentication credentials to verify the user;
identifying internal authentication credentials associated with the user, the internal authentication credentials having the same number and type of authentication factors as the input authentication credentials; and
authenticating the user on the network using the internal authentication credentials.

With existing systems, if the device that the user is operating to connect to the network is lost or compromised, and the internal authentication credentials stored on that device become compromised, there is a large security risk. The credentials may be illegitimately used to authenticate as the user and gain access to sensitive information on the internal network, and potentially other internal systems where the credentials can be used to authenticate for access to other systems. It is an advantage of the invention that the internal authentication credentials are not stored on any device or received from outside the network. This reduces the risk that the internal authentication credentials are compromised.

Some internal networks may only allow a limited number of attempts to authenticate, after which the user's entire account on the network is disabled, and administrative help is required to reset the password. This adds unnecessary expenses to the operation of the network. It is a further advantage of this invention that the user's account on the network will not be impacted by repeated attempts to authenticate the user using the external authentication credentials.

The client applications hosted by the network have pre-determined types of authentication credential factors, for example a Windows Exchange server typically requires a combination of a username and a text-based password. In turn, the software on the external device that the user is using requires the same username and password to authenticate with the exchange server. It is an advantage of the invention that the authentication factor types of both the external and internal authentication credentials are the same. In this way the software residing on the external device does not need to be customised or altered in any way to be used to authenticate the user according to the invention.

The input authentication credentials may include a username authentication factor and a password authentication factor.

The device may be a smartphone.

The input authentication credentials may include a password authentication factor, and the matching the input authentication credentials to the external authentication credentials is based on a hashed or encryption of the password.

In a second aspect there is provided software being computer readable instructions recorded on computer readable medium that when executed by a computer causes the computer to perform the method described above.

In a third aspect there is provided an authentication service system of authenticating a user for access to a network having:
a datastore to store for the user:
   external authentication credentials having one or more authentication factors, and each authentication factor having a type, and
   internal authentication credentials, the internal authentication credentials having the same number and type of authentication factors as the external authentication credentials;
an input port to receive from the user input authentication credentials from a device that is external to the network; and
a processor to match the input authentication credentials to the stored external authentication credentials to verify the user, identify the stored internal authentication credentials of the user; and to authenticate the user on the network using the internal authentication credentials.

In a fourth aspect there is provided an electronic non-volatile data store that stores for a user of a network:
external authentication credentials having one or more authentication factors, and each authentication factor having a type, wherein the external authentication credentials are used to verify a user by matching the external authentication credentials and input authentication credentials received from a device that is external to the network; and
internal authentication credentials having the same number and type of authentication factors as the external authentication credentials, wherein the internal authentication credentials are used to authenticate the user on the network after the user is verified.

In a fifth aspect there is provided a computer implemented method for associating external authentication credentials to a user comprising:
receiving authentication credentials from the user, the authentication credentials having one or more authentication factors, and each authentication factor having a type;
matching the received authentication credentials to stored internal authentication credentials to authenticate the user on the network; and
receiving or generating the external authentication credentials having the same number and type of authentication factors as the internal authentication credentials;
storing the external authentication credentials associated with the user on the data store.

In a sixth aspect there is provided software, being computer readable instructions recorded on computer readable medium that when executed by a computer causes the computer to perform the method described directly above.

In a seventh aspect, there is provided an authentication management service system for associating external authentication credentials to a user, comprising:
an input port to receive authentication credentials from the user, the authentication credentials having one or more authentication factors, and each authentication factor having a type;
a processor to match the received authentication credentials to internal authentication credentials to authenticate the user on the network and to generate the external authentication credentials having the same number and type of authentication factors as the internal authentication credentials; and
a data store to store the internal authentication credentials and the external authentication credentials associated with the user.

In an eighth aspect there is provided an authentication management service system for associating external authentication credentials to a user, comprising:
an input port to receive authentication credentials from the user, the authentication credentials having one or more authentication factors, and each authentication factor having a type;
a processor to match the received authentication credentials to the internal authentication credentials to authenticate the user on the network;
the input port to also receive the external authentication credentials having the same number and type of authentication factors as the internal authentication credentials; and
a data store to store the internal authentication credentials and the external authentication credentials associated with the user.

### BRIEF DESCRIPTION OF THE DRAWINGS

An example of the invention will now be described with reference to the accompanying drawings, in which:

FIG. 1 is a schematic diagram of a computer system comprising the network, user device and browser. This systems is one example of the deployment of the authentication service as it applies to connecting a multiple clients to a multiple servers, and authenticating clients from one or more networks and authenticating to servers in further networks.

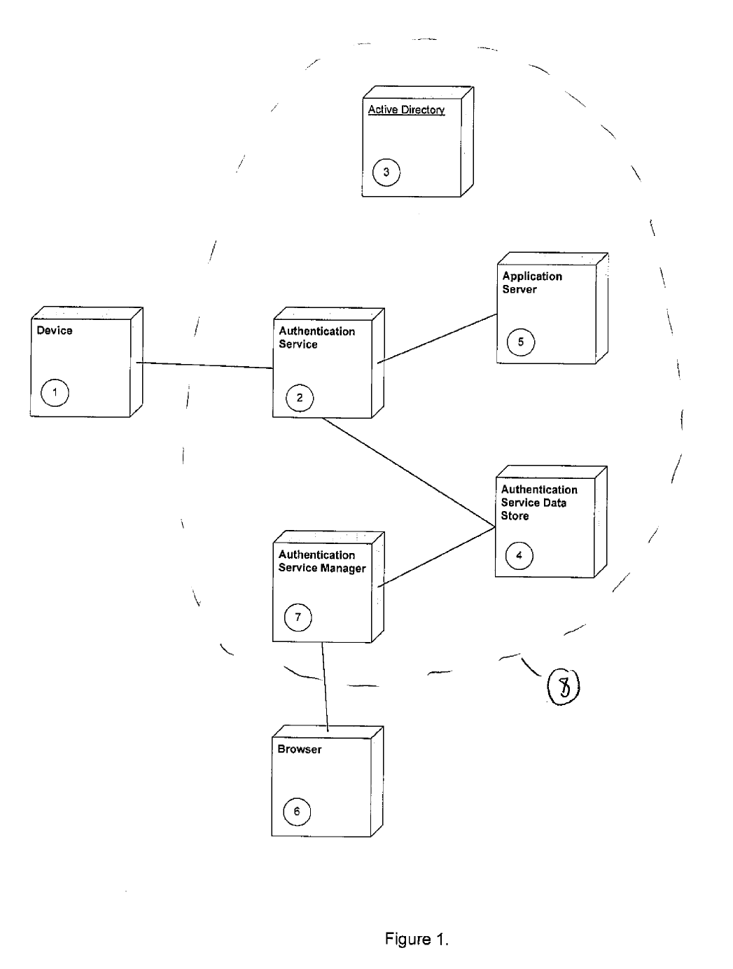

FIG. 2 shows an example method for authenticating a session from a user (client) from an external network, and authenticate the session to servers on an internal network.

FIG. 3 shows an example method to register a user for external access, and to configure the smartphone with the external credentials for external access.

FIG. 4 shows an example method undertaken to register a user for external access from a browser on a smartphone, with the system responding with a configuration profile which the smartphone uses for automatic configuration of its email account.

FIG. 5 shows an image of an Apple iPhone prompting the user to install a configuration profile following registration.

FIG. 6 shows an example configuration profile.

FIG. 7 shows an example browser interface.

### BEST MODES

In this example, the user connects to a network [1.8] using a device [1.1], in this case the network [1.8] is the computer network of their employer. The user's device [1.1] will typically be a smart phone or computer tablet. The device [1.1] is external to the network in the sense that it uses communication networks that the employer (or trusted organisation of the employer) does not have security control over, examples include public telephone networks and/or public WiFi networks. By comparison the network [1.8] is comprised of servers, clients and a data communications network that the employer (or trusted related organisation of the employer) does have control over, such as the employer's Local Area Network (LAN).

A person skilled in the art would understand that the user's device includes hardware and software to allow it to perform its part of the method described here. Importantly, the client applications on the user's device have not been enhanced or modified in order to perform its part of the method described here.

The device [1.1] connects to the an Application Server [1.5] of the network [1.8] using a Client-Server protocol via the Authentication Service [1.2]. The device may be on one network and the Application Server on a different network [1.8]. In this example, the protocol is the Hyper-Text Transport Protocol, which is a carrier for the Exchange ActiveSync protocol. The client application may be an email client. The Application Server may be an MS Exchange Server Exchange Active Sync Client Access Server (CAS).

The Authentication Service [1.2] has access to the Authentication Service Data Store [1.4]. The Authentication Service Data Store stores authentication information for each user being:
(1) internal authentication credentials. These authentication credentials can be used to authenticate the user to typically all or most systems in the network. The credentials are comprised of one or more authentication factors and each factor is of a particular type. Types include:
   user identifier, such as a user name
   phone number,
   password, including a single use password,
   challenge response,
   biometric identifiers,
   security or software token,
   security card,
   public certificate, and
   proof of access to a private key.
In this example there are two factors, the first being a user identifier type and the second being a password type, in particular a character password with a minimum of four characters.
(2) external authentication credentials. These are created according to a method that is described further below. The external authentication credentials have the same number and type of factors as the internal authentication credentials.

Some factors may be stored in an encrypted way, such as a hash value of the password factor.

In other examples, a user may have associated more than one external authentication credentials stored on the datastore.

A person skilled in the art would appreciate that the association between a user and their authentication credentials may be stored is a variety of different data structures, such as a relational database. The database could be structured a number of ways that would associate the internal and external authenticate of the same user together, such as directly to each such as in the same record.

The Authentication service data store [1.4] may be a distributed datastore. For example, one datastore may only store for each user the internal user identifier, and all the external authentication credentials. A second datastore may store all the internal authentication credentials for the user. The two records are associated by virtue of the common internal username.

Users and Administrators manage the user's internal and external authentication credentials using browsers [1.6], typically on personal computers that are either internal or external to the network [1.8] (depicted here as external) which access the Authentication Service Manager [1.7]. The Authentication Service Manager provides functionality such as registration, revocation and renewal. The Authentication Service Manager has access to the Authentication Service Data Store [1.4], and can set, change and remove relationships, and in the data store.

Active Directory [1.3] is used by components on the internal network for network authentication.

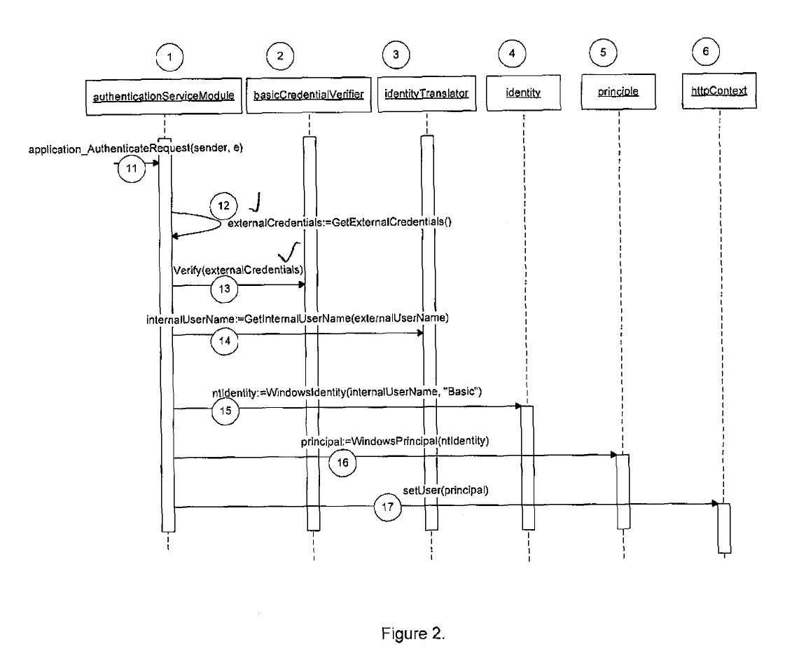

FIG. 2 shows an example of the sequence of events undertaken to authenticate a session from a user (client) from an external network, and authenticate the session to servers on an internal network.

The method is performed by one or more servers have the components [2.1-2.6] described here. For example, the method may be performed by a authentication server that is comprised of both software and hardware to perform the method described here.

This includes an input port where an authentication request [2.11] for web applications is received from a device external to the network. The request includes the authentication credentials as inputted by the user which if correct, are the same as the external authentication credentials stored by the Authentication Service Data Store [1.4]. The input credentials include a input username and a input password.

The remaining steps are driven by a processor. That is the Active Service Module programmed to respond to authentication requests for web applications. Following such an event [2.11], the Authentication Service Module retrieves the input authentication credentials from the session context [2.12].

The processor of the Authentication Service Module uses the Basic Credential Verifier [2.2] to verify the input authentication credentials [2.13] by comparing them with the external authentication credential stored on the data store [1.4]. The Basic Credential Verifier compares the input username with the username factors of external authentication credentials stored in the data store [1.4] until a match is found Once a matching record has been identified the Basic Credential Verifier [2.2] compares a hash of the input password with the hash of the password factor of the matching record. If the comparison is a match, then the user associated with that matching record is considered verified.

Next the internal authentication credentials of the verified user are identified, that is the processor operates to retrieve [2.14] from the data store [1.4] the internal authentication credentials associated with the verified user.

The Authentication Service Module constructs a Windows Identity [2.4], based on the user name of the internal authentication credentials [2.15], and then constructs a Windows Principal [2.5] based on the constructed Windows Identity [2.16].

The Authentication Service Module sets the User attribute of the session content [2.6] to the created Windows Identity [2.17] which has the effect of authenticating the user on the network.

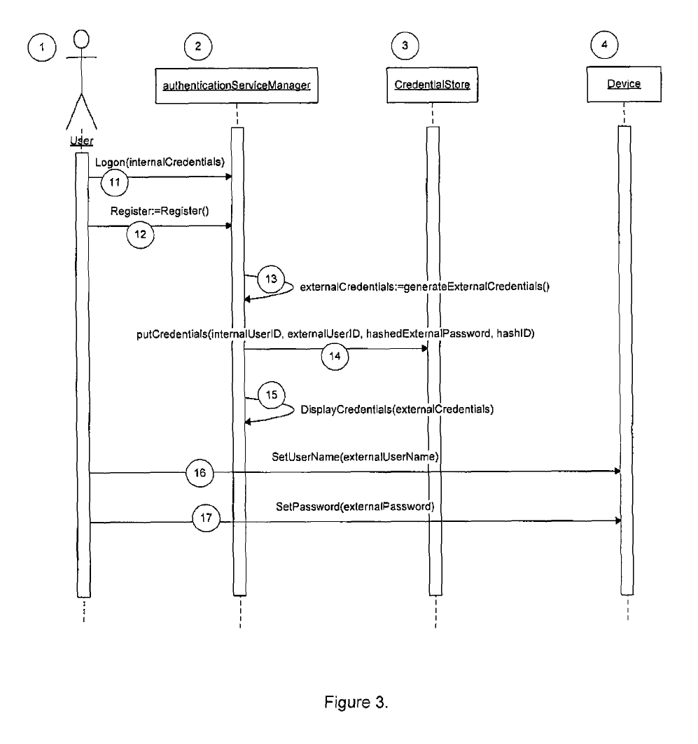

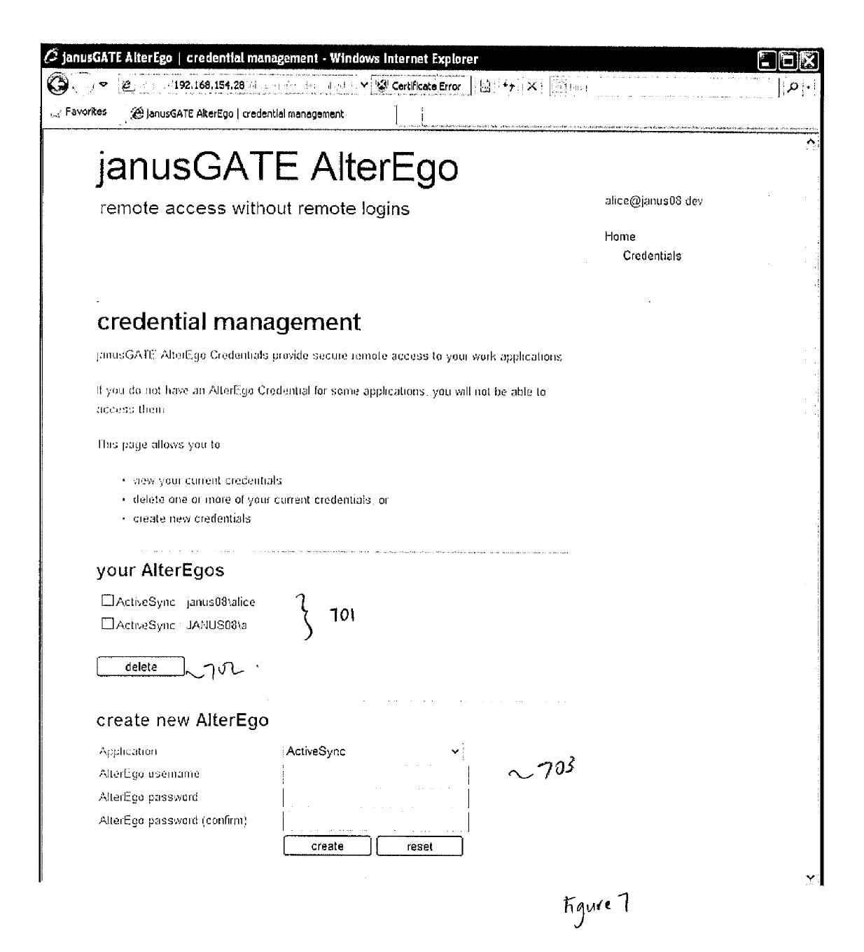

FIG. 3 shows an example of the sequence of events undertaken for a user to register for external access, and to manually configure the smartphone with the external credentials for external access. A sample browser user interface that is presented to the user is shown in FIG. 7. It shows that in this example the user already has two different external authentication credentials 701 which can be deleted 702. Alternatively, further external authentication credentials can be created 703. A similar interface that allows the same functions to be performed by an administrator but for all users is presented to the administrator based on the administrator's login.

The user [3.1] logs on [3.11] to the Authentication Service Manager [3.2]. In one example the Service Manager is a server that should be considered as a combination of both software and hardware that allow it to perform the method described here. The user authenticates to the Authentication Service Manager [3.2] using the credentials known to the internal network. The Authentication Service Manager [3.2] authenticates the user by accessing the data store [1.4] that has the user's internal authentication credentials stored. Again the internal authentication credentials have or more authentication factors, and each authentication credential factor having a type. In this case, the internal authentication credentials are again username and password.

Once authenticated, the user [3.1] begins registration [3.12] with the Authentication Service Manager [3.2] The Authentication Service Manager [3.2] generates a set of external credentials, again of the same number and type of factors as the internal credentials, username and password, for the user for use on devices external to the network [3.13].

The Authentication Service Manager [3.2] hashes the external password with a pre-specified hashing algorithm. The Authentication Service Manager [3.2] saves [3.14] the internal username (retrieved from the initial logon), the external username, and the hashed external password and an identifier associated with the hashing algorithm to the Credential Store [3.3] ([1.4]). The different way the internal and external authentication credential can be associated with the same user in memory is discussed above.

The Authentication Service Manager [3.2] displays [3.15] the external credentials to the User [3.1].

The User [3.1] saves the external identity [3.16] and the external password [3.17] to the smart phone's email account settings [3.4].

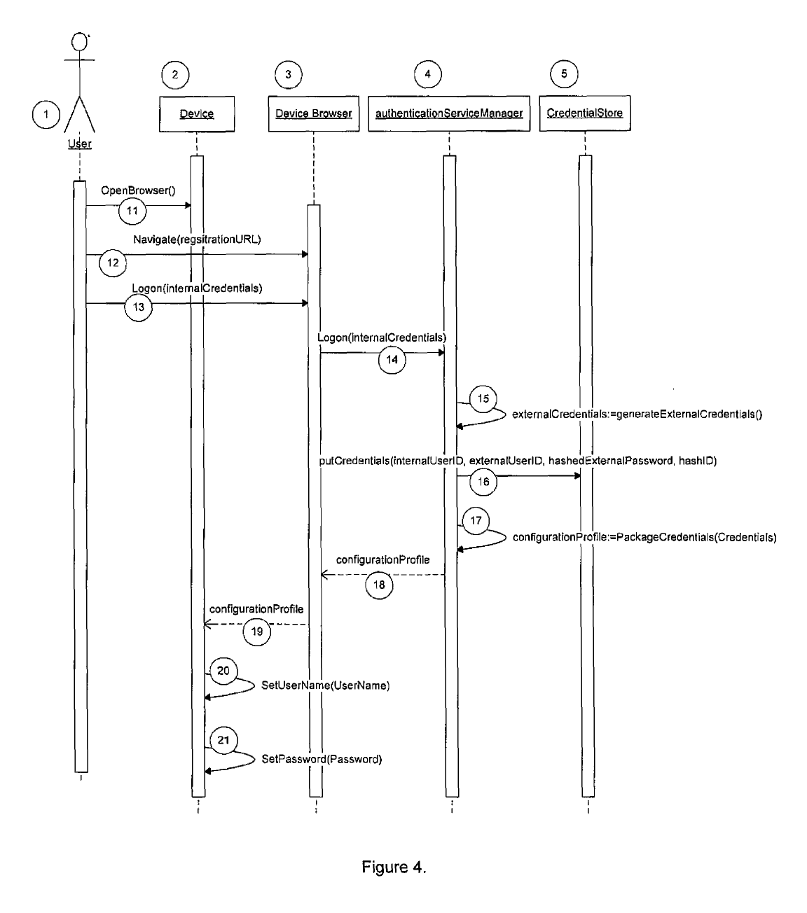

FIG. 4 shows the method for registering a user for external access from a browser on a smartphone, with the system responding with a configuration profile which the smartphone uses for automatic configuration of its email account.

The user [4.1] opens the browser [4.11] on the smartphone [4.2]. The user navigates to the advertised Uniform Resource Locator (URL) for registration [4.12], which locates the Authentication Service Manager [4.4]. The user enters internal authentication credentials into the browser [4.13]. The browser forwards the credentials to the Authentication Service Manager [4.14]. The Authentication Service Manager authenticates the credentials for the internal network.

The Authentication Service Manager generates a set of external credentials [4.15] that again have the same number and type of factors as the internal authentication protocols. The Authentication Service Manager hashes the external password with a pre-specified hashing algorithm. The Authentication Service Manager saves [4.16] the internal user identity (from step 4.14), the external user identity, the hashed external password and an identifier associated with the hashing algorithm to the Credential Store [4.5].

The Authentication Service Manager packages the external credentials and other information, such as the email address and server name, for the phone configuration into a configuration profile file [4.17], which is returned to the smartphone's browser [4.18]. The smartphone recognises the file as a profile [4.19] and begins installing when instructed by the user. The smartphone automatically sets the email account's username and password, as specified by the configuration profile [4.20, and 4.21].

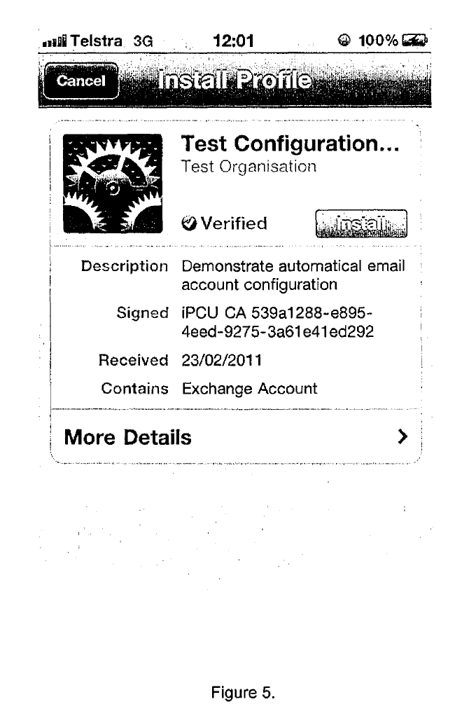

FIG. 5 shows an image of an Apple iPhone prompting the user to install a configuration profile following registration. The image shows that the configuration profile contains Exchange Account, that is Exchange ActiveSync client configuration information.

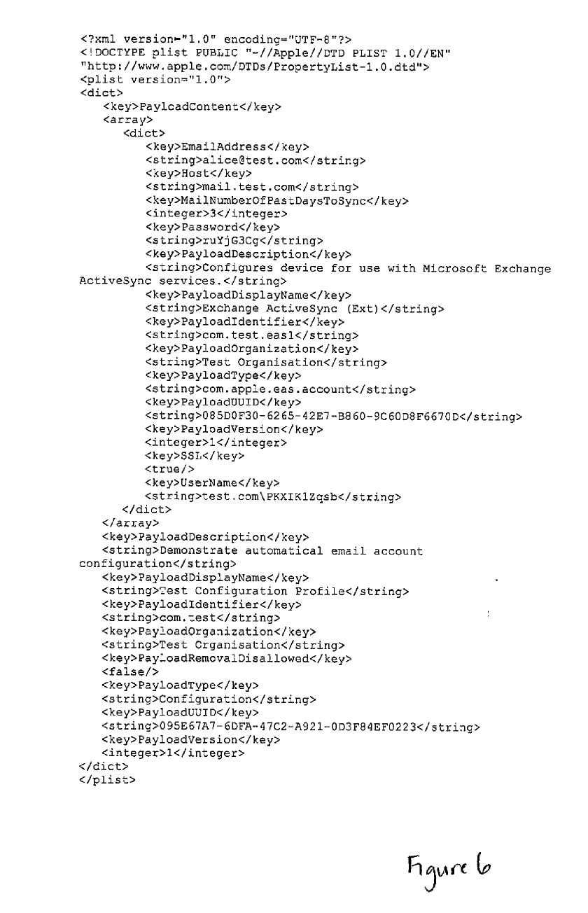

FIG. 6 shows an example of a configuration profile, used to configure the ActiveSync client on an Apple IPhone. The file contains the username for use on the external network (lines 34 and 25), and the associated password (lines 15 and 16).

It will be appreciated by persons skilled in the art that numerous variations and/or modifications may be made to the above-described embodiments, without departing from the broad general scope of the present disclosure.

For example the external authentication credentials may be selected by the user or automatically generated by the authentication service manager.

The clients may be mobile devices with web browsers, such as smartphones, which use the HTTP to communicate with web servers.

The authentication service may operate as part of a web application. Alternatively, the authentication service operates as part of a proxy for a web application.

Verification of the external authentication credential may be based on a comparison of encrypted versions of one or more factors.

The authentication service may verify the input authentication credentials presented by comparing the output of a one-way function (hash) applied to the input password with the stored value of the same one-way function applied to the external password for the user name.

The authentication service may verify the input authentication credentials by comparing the input password that is received already hashed with a stored hashed external password value for user name.

The authentication service may verify these credentials by validating the digital signature and the public key certificate.

The authentication service processes additional session, identity, and/or account information to authorise the client. Additional information may include, but is not limited to one or more of: a device identifier, a device model identifier, an application identifier, the client's network, the client's Internet Protocol (IP) address, network Access Point Name (APN), the resource requested by the client, time of day, day of week, identity status, and account financial status. The identity status may be one of, but not limited to: unknown, registered, approved, revoked, expired. Processing may include, but is not limited to: comparison with preset values, comparison of hashed values with preset values, or a combination of processes. Comparison includes, but is not limited to: tests for equivalence with one preset value, tests for equivalence with one of a set of preset values, tests that a value is less than, less than or equal to, greater than, or greater than or equal to a preset value, tests that a value is within the limits of a range specified by two preset values, tests for group membership, and regular expression tests against preset values. Combinatorial processing includes, but is not limited to logical-and operations, logical-or operations, logical inversion, n-of-m operations and weighted sum operations.

The configuration of the processes and combinations may be set on per site basis. Alternatively, the configuration of the processes and combinations are set on per customer basis.

Configuration of the processes and combinations are stored in the data store. Preset values required for assessment of additional session metadata may be stored in a data store.

The data store may be a random access memory of the authentication service server. Alternatively, the data store is an electronic file. Alternatively, the data store is a database. Alternatively, the data store is a directory, such as an X.500 directory. Alternatively, the data store may be a Lightweight Directory Access Protocol (LDAP) directory.

The authentication service manager registers a user using their internal authentication credentials to then generate the external authentication credentials. Then storing the internal username and the external authentication credentials to the data store. Alternatively, the user may supply the external authentication credentials that is provided as input to the authentication service manager.

The authentication service manager may register a user by storing the hash of the external password to the data store.

The user may configure the device's email account using the credentials generated and presented to the user by the authentication service manager.

The user may be any entity having access to the network. The authentication service manager may register entities by authenticating a system acting on behalf of an entity.

The system acting on behalf of the user is a Microsoft or Apple Mobile Device Management (MDM) server. The request from the MDM server to the authentication service manager, contains the internal user identity corresponding to the user for whom the device is intended. The authentication service manager registers the nominated user, and returns a configuration profile containing the user's external authentication credentials.

The request from the MDM server may include the device certificate.

The configuration profile may be encrypted. Alternatively, part of the configuration profile is encrypted.

A user (entity) may register for external authentication credential using a web browser which accesses the authentication service manager. Alternatively, an administrator registers may register a user (entity) for alternative credential access using a web browser which accesses the authentication service manager. The web browser may operate from a workstation internal of the network. Alternatively, the web browser may operate from a mobile device.

A user (or administrator) may register for alternate credential access using a software application which accesses the authentication service manager. The software application may operate from a workstation internal of the network. Alternatively, the software the application may operate from a mobile device. The software application may automatically configure the mobile device to uses the credentials generated by the authentication service manager.

The authentication service may be operated by the same organisation which is responsible for the security of the information. Alternatively, the authentication service may be operated by a third party who provides the authentication service as a third party service.

The authentication service may be an appliance. The authentication service may be co-located with the application server. The authentication service may operate as an extension to a web server. The authentication service may operates on a single machine. The authentication service may operate as a cluster of machines.

It should be understood that the techniques described here might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “matching”, “identifying”, “processing”, “generating” or “computing” or “calculating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A computer-implemented method of authenticating a user for access to a network, the method comprising:
receiving input authentication credentials from the user using a device that is external to the network, the input authentication credentials having one or more authentication factors, and each authentication factor having a type;
matching the input authentication credentials to stored external authentication credentials to verify the user;
identifying internal authentication credentials associated with the user, the internal authentication credentials having the same number and type of authentication factors as the input authentication credentials; and
authenticating the user on the network using the internal authentication credentials.

2. The method of claim 1, wherein the input authentication credentials include a username authentication factor and a password authentication factor.

3. The method of claim 1, wherein the device is a smartphone.

4. The method of claim 1, wherein the input authentication credentials include a password authentication factor, and the matching the input authentication credentials to the external authentication credentials is based on a hashed or encryption of the password.

5. Software, being computer readable instructions recorded on computer readable medium that when executed by a computer causes the computer to perform the method of claim 1.

6. A authentication service system of authenticating a user for access to a network having:
a datastore to store for the user:
external authentication credentials having one or more authentication factors, and each authentication factor having a type, and
internal authentication credentials, the internal authentication credentials having the same number and type of authentication factors as the external authentication credentials;
an input port to receive from the user input authentication credentials from a device that is external to the network; and
a processor to match the input authentication credentials to the stored external authentication credentials to verify the user, identify the stored internal authentication credentials of the user; and to authenticate the user on the network using the internal authentication credentials.

7. An electronic non-volatile data store that stores for a user of a network:
external authentication credentials having one or more authentication factors, and each authentication factor having a type, wherein the external authentication credentials are used to verify a user by matching the external authentication credentials and input authentication credentials received from a device that is external to the network; and
internal authentication credentials having the same number and type of authentication factors as the external authentication credentials, wherein the internal authentication credentials are used to authenticate the user on the network after the user is verified.

8. A computer implemented method for associating external authentication credentials to a user comprising:
receiving authentication credentials from the user, the authentication credentials having one or more authentication factors, and each authentication factor having a type;
matching the received authentication credentials to stored internal authentication credentials to authenticate the user on the network; and
receiving or generating the external authentication credentials having the same number and type of authentication factors as the internal authentication credentials;
storing the external authentication credentials associated with the user on the data store.

9. Software, being computer readable instructions recorded on computer readable medium that when executed by a computer causes the computer to perform the method of claim 8.

10. A authentication management service system for associating external authentication credentials to a user, comprising:
an input port to receive authentication credentials from the user, the authentication credentials having one or more authentication factors, and each authentication factor having a type;
a processor to match the received authentication credentials to internal authentication credentials to authenticate the user on the network and to generate the external authentication credentials having the same number and type of authentication factors as the internal authentication credentials; and
a data store to store the internal authentication credentials and the external authentication credentials associated with the user.

11. A authentication management service system for associating external authentication credentials to a user, comprising:
an input port to receive authentication credentials from the user, the authentication credentials having one or more authentication factors, and each authentication factor having a type;
a processor to match the received authentication credentials to the internal authentication credentials to authenticate the user on the network;
the input port to also receive the external authentication credentials having the same number and type of authentication factors as the internal authentication credentials; and
a data store to store the internal authentication credentials and the external authentication credentials associated with the user.
